(19) United States
(12) Patent Application Publication
(10) Pub. No.: US 2006/0080190 A1
(43) Pub. Date: Apr. 13, 2006

(54) Method and system for storing goods trace information

(76) Inventors: Isao Furukawa, Fanabashi-shi (JP); Shoichi Nakagami, Irima-gun (JP); Takashi Yanagita, Koto-ku (JP); Hirohisa Shimonaga, Yokohama-shi (JP); Junichi Matsuda, Higashimurayama-shi (JP); Kazuaki Suzuki, Funabashi-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/237,861

(22) Filed: Sep. 29, 2005

(30) Foreign Application Priority Data
Sep. 30, 2004 (JP) 2004-288812

(51) Int. Cl. G06Q 99/00

(52) U.S. Cl. 705/28

(57) ABSTRACT

The present invention provides a goods trace information storing method comprising the steps of: acquiring identification information from an RFID (Radio Frequency Identifier) tag in each distribution level by an identification information read mechanism, and acquiring physical property information of goods, where the RFID tag is attached, by a physical quantity measurement mechanism; a comparison determination mechanism's comparing the physical property information with predetermined threshold information and outputting determination information comprising information for indicating whether or not the physical property information is out of a range of the threshold information; and a registration mechanism's making the acquired identification information, physical property information, and determination information correspond to information for identifying the information group, including information for specifying an acquisition time and an acquired distribution level, and storing them in a memory mechanism.

### BACKGROUND OF THE INVENTION

1. Field of the Invention

The present invention relates to a method and a system for accumulating information used for traceability, and particularly, to a goods trace information storing method and system for accumulating information that can specify an occurrence place of a defect occurring in a distribution level of goods together with trace information of the goods.

2. Description of the Related Art

Accompanied with heightening of a concern of a common consumer about food safety, various traceability systems are proposed in a distribution of perishable goods and the like. For example, in Japanese Patent Laid-Open Publication No. 2004-78743 (paragraphs 0024 to 0038, FIG. 6) a traceability system is disclosed where information relating to an agricultural product is input from a terminal in each level of a sale and that stores the information in a server.

However, in the traceability system disclosed in Japanese Patent Laid-Open Publication No. 2004-78743, it is only possible to look up such information relating to a passing time, place, handling of the agricultural product in each level of a distribution, and when there occurs a defect such as a breakage, deformation, or discoloration in the agricultural product distributed, it is difficult to specify a place where the defect occurred.

In addition, in order to identify a defect of goods in a line of a plant and the like, equipment is proposed that uses a video camera, a sensor for measuring various physical quantities, and the like, and that detects the defect in a manufacturing or process level. For example, in Japanese Patent Laid-Open Publication No. Hei. 4-122844 (page 3, left upper line 4 to right upper line 18, and FIG. 1) is proposed defect inspection equipment that radiates laser light to goods of an inspection object and detects defect of the goods from an intensity distribution of its reflection light.

However, such the defect inspection equipment only identifies goods deviated from a prescription in a place, where the equipment is installed, and cannot identify a place where a defect occurred in the goods deviated from the prescription, tracing a process in a previous level of the equipment.

Consequently, it is strongly requested a goods trace information storing method and system for accumulating information that can specify an occurrence place of a defect when there occurred the defect in object goods in each distribution level thereof.

### SUMMARY OF THE INVENTION

The present invention provides a goods trace information storing method comprising the steps of: acquiring identification information from an RFID (Radio Frequency Identifier) tag in each distribution level by an identification information read mechanism, and acquiring physical property information of goods, where the RFID tag is attached, by a physical quantity measurement mechanism; a comparison determination mechanism's comparing the physical property information with predetermined threshold information and outputting determination information comprising information for indicating whether or not the physical property information is out of a range of the threshold information; and a registration mechanism's making the acquired identification information, physical property information, and determination information correspond to information for identifying the information group, including information for specifying an acquisition time and an acquired distribution level, and storing them in a memory mechanism.

Furthermore, the present invention provides a goods trace information storing system comprising: an identification information read mechanism for acquiring identification information stored in an RFID tag in each distribution level; a physical quantity measurement mechanism for acquiring physical property information of goods; a comparison determination mechanism for comparing the physical property information with predetermined threshold information and outputting determination information that comprises information for indicating whether or not the physical property information is out of a range of the threshold information; a memory mechanism for storing the identification information, the physical property information, and the determination information; and a registration mechanism's making the acquired identification information, physical property information, and determination information correspond to information for identifying the information group, including information for specifying an acquisition time and an acquired distribution level, and storing them in a memory mechanism.

### BRIEF DESCRIPTION OF THE DRAWINGS

FIG. 1 is a drawing showing a configuration of a goods trace information storing system.

FIG. 2 is a drawing showing an equipment configuration of check points.

FIG. 3 is a block configuration diagram of control equipment.

FIG. 4 is a flowchart illustrating a process of executing determinations, based on image information, and storing information in a traceability DB and an image feature quantity DB in control equipment.

FIG. 5 is a drawing illustrating an embodiment where a goods trace information storing system is applied to a distribution of an agricultural product.

FIG. 6 is a drawing illustrating an embodiment where a goods trace information storing system is applied to an inspection process of a processing plant and the like.

FIG. 7 is a flowchart illustrating a process of storing information of a manufacturing number in an individual goods attribute DB in control equipment.

### DESCRIPTION OF THE PREFERRED EMBODIMENTS

Here will be described an embodiment of the present invention, referring to attached drawings. In the embodiment will be described a goods trace information storing system and method that output determination information for determining a defect occurring in goods in each process of a distribution, acquire identification information for identifying the goods from an RFID tag, and match and store these pieces of the information, using image information where the goods of a distribution object is taken.

Here, the RFID is equipment configured of a small IC (Integrated Circuit) chip for storing own identification information and a metal antenna, and can be used as a tag for identifying goods by being affixed thereto.

Identification information stored in the IC chip of the RFID tag can be read with no contact by using a dedicated RFID reader. The RFID reader sends an electric wave or an electromagnetic wave according to a kind of the RFID tag, and supplies electric power to the RFID tag by no-contact power transmission technology. The RFID tag can send the identification information stored in its own IC chip by the electric power.

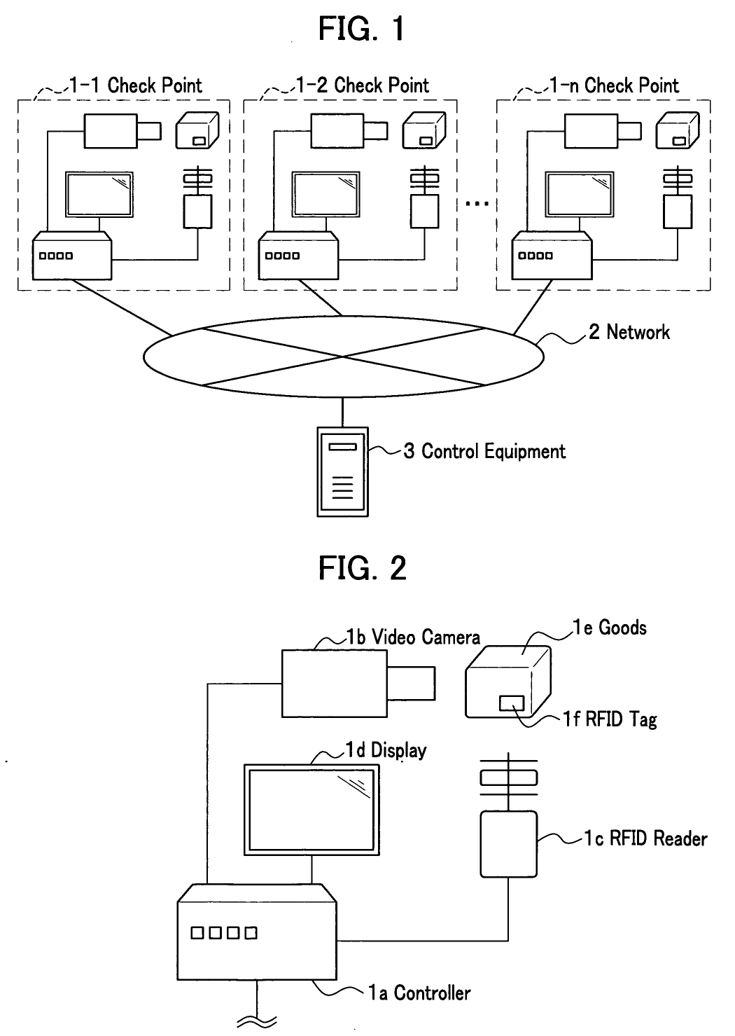

Firstly, the goods trace information storing system of the embodiment will be described. As shown in FIG. 1, the goods trace information storing system is mainly configured of check points 1-1, 1-2, . . . , 1-n (hereinafter abbreviated to “check point 1”) installed in each process of a distribution of goods via a network 2 and a control equipment 3 for storing information sent from each check point 1.

Next will be described each component of the goods trace information storing system shown in FIG. 1 in detail.

[Check Point]

As shown in FIG. 2, the check point 1, where a plurality of instruments is connected, is mainly configured of a controller 1a for sending information and the like sent from the instruments, a video camera 1b for taking an image of a goods 1e where an RFID tag 1f is affixed, an RFID reader 1c for reading identification information stored in the RFID tag 1f, and a display 1d for displaying such a determination result for a threshold described later.

Next will be described each component of the check point 1 more in detail.

[Controller]

The controller 1a comprises at least functions of: sending image information where the goods 1e is cut out from an image taken by the video camera 1b and identification information of the goods 1e sent from the RFID reader 1c; and displaying a determination result for a threshold received from the control equipment 3.

The controller 1a is embodied by a computer comprising: interfaces of the video camera 1b, the RFID reader 1C, and the display 1d; an information processing unit for detecting and cutting out the goods 1e from the image taken by the camera 1b, outputting it as the image information, and creating information of a screen display displayed in the display 1d; and a communication unit for sending the control equipment 3 the identification information sent from the RFID reader 1c, the image information output by the information processing unit, and the like.

The controller 1a sends the control equipment 3 a check point ID for identifying the check point 1 where the controller 1a is installed, information of time when the controller 1a or the RFID reader 1c detects the goods 1e, and the like. In addition, when the check point 1 is movably operated, a PDA (Personal Digital Assistant) can be used as the controller 1a, and the PDA and the network 2 may also be connected by a radio communication mechanism.

[Video Camera]

The video camera 1b corresponding to the image input mechanism in the “SUMMARY OF THE INVENTION” takes an image of the goods 1e of an object and transmits it to the controller 1a. The image of the goods 1e taken as image information by the video camera 1b is cut out if the controller 1a detects the goods 1e, and the image information is sent to the control equipment 3 via the network 2.

[RFID Reader]

The RFID reader 1c executes no-contact power transmission by sending an electric wave and an electromagnetic wave to the RFID tag 1f, and if receiving a signal containing identification information sent from the tag 1f, the reader 1c extracts the identification information and sends it to the controller 1a.

In a case that the goods 1e is placed on such a conveyor and transferred, the RFID reader 1c is disposed at a position where an electric wave and an electromagnetic wave received by the RFID tag 1f does not become not more than a minimum operation intensity. In addition, in a case that the check point 1 is movably operated, a handy-type RFID reader 1c can be used.

Meanwhile, in the embodiment, although the RFID tag 1f is designed to be used as a carrier of the identification information of the goods 1e, it is also enabled to use a barcode of one-dimensional code, two-dimensional code, and the like; however, it is preferable to use the RFID tag 1f that can be used with no contact, and that is difficult to receive an influence on a read performance depending on an affixation place of a tag.

[Display]

In the display 1d can be displayed determination information for a threshold of a feature quantity of the goods 1e described later by the control equipment 3. Here, in a case that the feature quantity of the goods 1e has deviated from the threshold, it is also available to display the determination information and a difference from the image information and the threshold used in the determination.

Meanwhile, in a case that the PDA is used as the controller 1a, the display 1d becomes integrated with the controller 1a. In addition, the display 1d is not an essential component for the present invention, and followings can also be thought of: a configuration not comprising the display 1d; and a configuration of lighting a lamp and/or sounding a buzzer instead of the display 1d, using a relay circuit if the goods 1e is determined to be “defective.”

[RFID Tag]

The RFID tag 1f affixed to the goods 1e receives electric power with no contact from the RFID reader 1c by receiving an electric wave or an electromagnetic wave, and sends the reader 1c a signal containing identification information for identifying the tag 1f stored in advance in the IC chip.

The RFID tag 1f is not only directly affixed to the goods 1e, but also affixed to a pallet where the goods 1e is put, or else attached to the goods 1e as a shipping tag, and the tag 1f passes through the check point 1 together with the goods 1e throughout a communication process in various patterns.

[Control Equipment]

The control equipment 3 receives such image information and identification information of the goods 1e sent from a plurality of the check point 1 via the network 2 and stores them, processes the received image information and extracts a feature quantity, outputs determination information for indicating whether or not the feature quantity has deviated from the threshold by comparing the feature quantity with a predetermined threshold, and executing a character recognition for the received image information and outputs a character code.

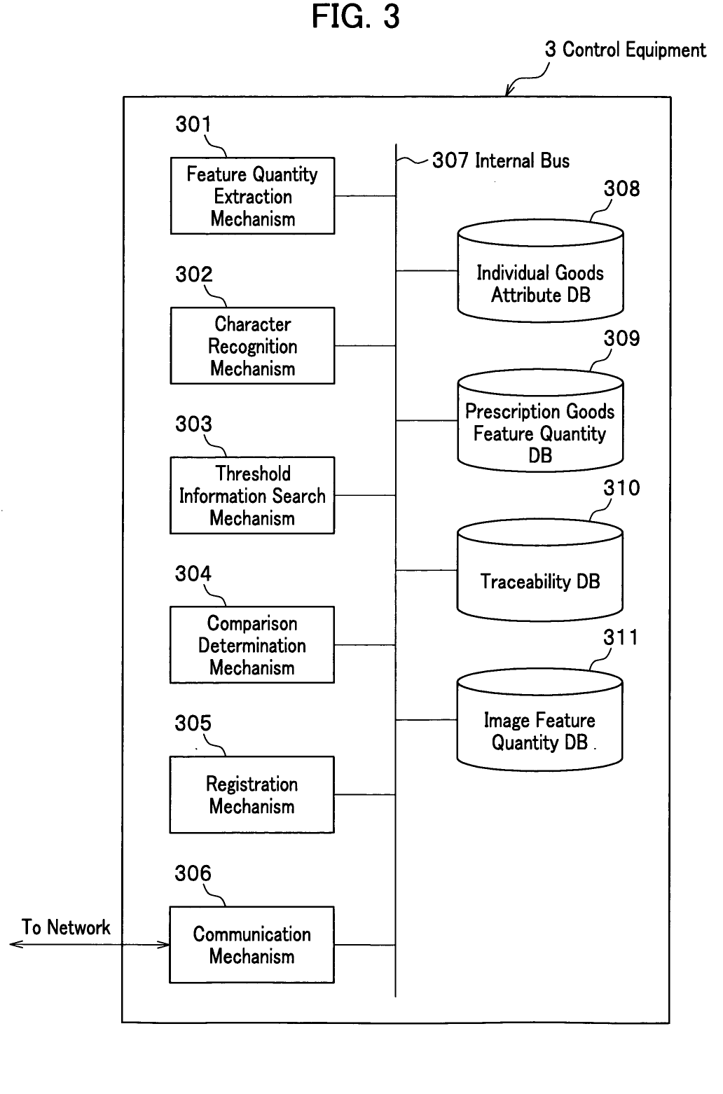

The control equipment 3 comprises a CPU (Central Processing Unit), a RAM (Random Access Memory), a ROM (Read Only Memory), and a hard disk drive, and is typically realized by a server computer communicable with the network 2. The control equipment 3 deploys a dedicated program stored in the hard disk drive into the RAM, the CPU runs the program, and thereby the equipment 3 operates as the equipment 3. A functional block diagram of the control equipment 3 is exemplified in FIG. 3 when the dedicated program is run.

As shown in FIG. 3, the control equipment 3 comprises a feature quantity extraction mechanism 301 for extracting image feature information of feature quantities such as a size and color of the goods 1e from the image information of the goods 1e sent from the controller 1a; a character recognition mechanism 302 for executing the character recognition from the image information and outputting a character code; and a threshold information search mechanism 303 for searching the threshold of the feature quantities of the goods 1e as threshold information from a prescription goods feature quantity DB 309 described later.

Furthermore, the control equipment 3 comprises a comparison determination mechanism 304 for comparing the image feature information of the goods 1e extracted by the feature quantity extraction mechanism 301 with the threshold information searched by the threshold information search mechanism 303, and outputting the determination information for indicating whether or not the image feature information has deviated from the threshold information; a registration mechanism 305 for registering information in a traceability DB 310, an image feature quantity DB 311, and the like described later; and a communication mechanism 306 for communicating with the controller 1a of the check point 1 via the network 2: these mechanisms and respective data bases described later are connected by an inner bus 307.

In addition, the control equipment 3 comprises the respective data bases of an individual goods attribute DB 308, the prescription goods feature quantity DB 309, the traceability DB 310, and the image feature quantity DB 311, and the data bases are realized by allotting areas on a hard disk of the control equipment 3. Here will be described the respective data bases of the control equipment 3 and the information stored therein, citing examples.

The individual goods attribute DB 308 is the identification information stored in the RFID tag 1f affixed to the goods 1e and a data base where the information relating the goods 1e corresponding the identification information is stored. Here, Table 1 exemplifies information stored in the individual goods attribute DB 308, and unique information to the goods 1e such as a type number and a manufacturing number thereof is stored for every piece of identification information identifying the goods 1e.

Meanwhile, in such a case that a kind of handled goods 1e is one, the type number of the goods 1e can also be omitted.

TABLE 1
Example of Information Stored in Individual Goods Attribute DB

| Identification | | Manufacturing | |
|---|---|---|---|
| Information | Type Number | Number | . . . |
| 12345 | AFGI-ESE3 | T453-549584 | . . . |
| 12346 | AFGI-ESE3 | T453-549585 | . . . |
| . | . | . | . |
| . | . | . | . |
| . | . | . | . |

Next, the prescription goods feature quantity DB 309 is a data base where thresholds of the feature quantities such as a size and color of the goods 1e are stored for every type number thereof, and in a case that the goods 1e has a plurality of the thresholds in such a distribution level and a processing level, even in same goods 1e it is also enabled to set threshold information for every check point ID specifying the check point 1. In addition, as the set threshold information can also be set a value having a predetermined width (upper limit value and lower limit value) and a value divided into a plurality of areas other than the upper limit value or the lower limit value. Here, Table 2 exemplifies the information stored in the prescription goods feature quantity DB 309; and the threshold information such as the color, shape, and size of the goods 1e is stored according to the check point ID for specifying each check point 1 and the type number of the goods 1e.

Meanwhile, a configuration of omitting the prescription goods feature quantity DB 309 is also enabled by in advance storing the threshold information stored in the DB 309 shown in Table 2 in the RFID tag 1f affixed to the goods 1e.

TABLE 2
Example of Information Stored in Prescription
Goods Feature quantity DB

| Check | | | | | |
|---|---|---|---|---|---|
| Point ID | Type Number | Color | Shape | Size | . . . |
| C1001 | AFGI-ESE3 | — | Sphere | Min. 30 × 30 × 30 | . . . |
| C1001 | AFGI-ESE4 | Blue | Sphere | Max. 40 × 40 × 40 | . . . |
| . | . | . | . | . | . |
| . | . | . | . | . | . |
| . | . | . | . | . | . |

Next, the traceability DB 310 is a data base where the check point ID for identifying the check point 1 where the goods 1e passed, passing time of the check point 1, and determination information output by the comparison determination mechanism 304 are stored; these pieces of the information are stored with being made to correspond to a trace ID uniquely produced by the registration mechanism 305 in order to specify each record.

Here, Table 3 exemplifies the information stored in the traceability DB 310; the information comprises the identification information of the goods 1e, the check point ID, the passing time of the goods 1e, and the determination information output by the comparison determination mechanism 304, and is stored with being made to correspond to the trace ID produced by the mechanism 305.

Meanwhile, in the embodiment, although as the RFID tag 1f is shown an example of a ROM type of the tag 1f where the identification information is stored, it is also enabled to store information relating to the tag 1f stored in the traceability DB 310 in the tag 1f itself in a case of using a RAM type of the tag 1f.

TABLE 3
Example of Information Stored in Traceability DB

| | | Check | | | |
|---|---|---|---|---|---|
| Trace | Identification | Point | | Determination | |
| ID | Information | ID | Passing Time | Information | . . . |
| AA001 | 12345 | C1001 | 2004/6/24/13:31 | O | . . . |
| AA002 | 12345 | C1002 | 2004/6/24/15:18 | O | . . . |
| . | . | . | . | . | . |
| . | . | . | . | . | . |
| . | . | . | . | . | . |

Then in the image feature quantity DB 311 is stored the image feature information of the goods 1e extracted by the feature quantity extraction mechanism 301, the information of the character code included in the image information recognized by the character recognition mechanism 302, or the like with being made to correspond to the Trace ID for identifying each record of the traceability DB 310 described above.

Here, Table 4 exemplifies the information stored in the image feature quantity DB 311; the information comprises the color, shape, and maximum width of the goods 1e of the image feature information output by the feature quantity extraction mechanism 301, and is stored in the DB 311 with being made to correspond to the trace ID. In addition, it is also enabled to store the image information sent from the controller 1a as it is in the image feature quantity DB 311.

TABLE 4
Example of Information Stored in Image Feature Quantity DB

| Trace ID | Color | Shape | Maximum width | . . . |
|---|---|---|---|---|
| AA001 | — | Sphere | 31 | . . . |
| AA038 | Blue | Sphere | 38 | . . . |
| . | . | . | . | . |
| . | . | . | . | . |
| . | . | . | . | . |

Meanwhile, in the embodiment, although it is assumed that the control equipment 3 comprises respective mechanisms for executing image processings such as the extraction of the image feature information and the character recognition, a configuration is also available that the controller 1a executes the image processings and the control equipment 3 comprises the respective data bases, the threshold information search mechanism 303, and the registration mechanism 305. In addition, it is also enabled to design so as to disperse the function of the control equipment 3 into a plurality of server computers.

In addition, in the embodiment, although it is designed to acquire the image feature information as the feature quantity of the goods 1e, it is also available to design so as to acquire weight information as the feature quantity of the goods 1e, for example, by connecting a weighing machine as a physical quantity measurement mechanism instead of the video camera 1b. Thus by changing equipment for measuring the physical quantity of the goods 1e, it is enabled to acquire various physical quantities as physical property information.

[Operation of Control Equipment]

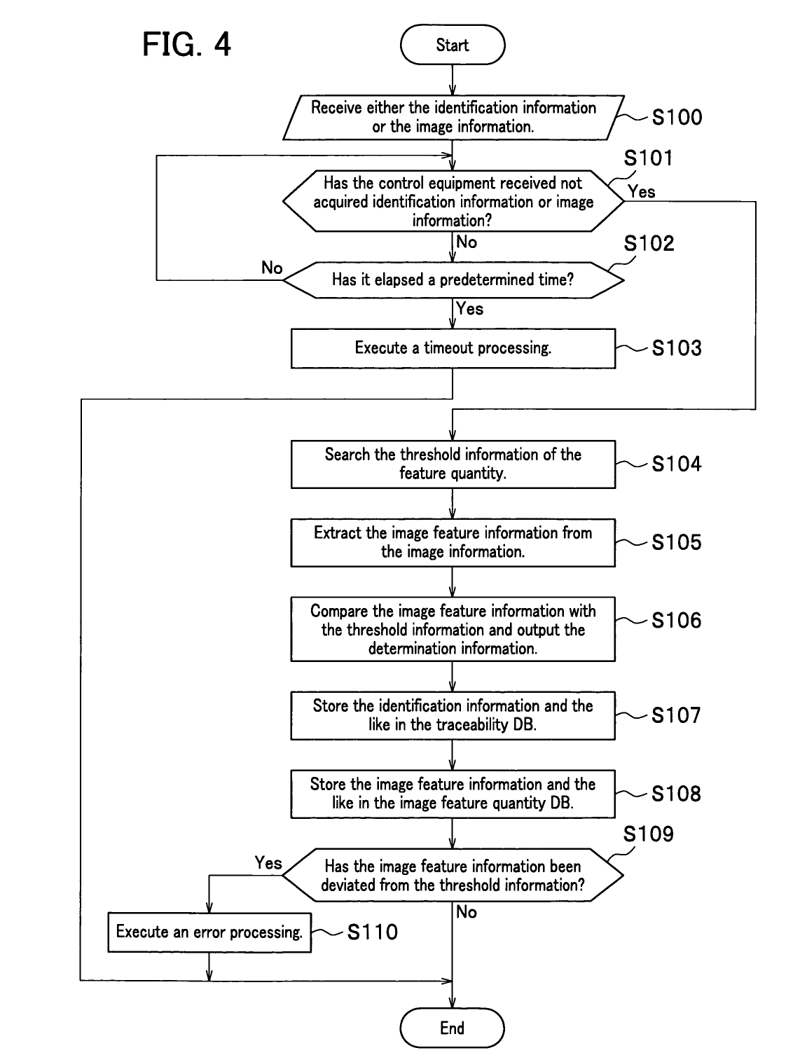

Next will be described a process till the control equipment 3 stores information in the traceability DB 310 and the image feature quantity DB 311, when the goods 1e passes through the check point 1, referring to a flowchart shown in FIG. 4 (see FIGS. 1 and 3 as needed).

Here will be described an operation of the control equipment 3 in a case that: the equipment 3 extracts image feature information from image information of the goods 1e, compares the image feature information with threshold information stored in the prescription goods feature quantity DB 309 and outputs the determination information, and stores each piece of the information in the traceability DB 310 and the image feature quantity DB 311.

For example, if the RFID tag 1f affixed to the goods 1e placed on a belt conveyor enters in a detection range of the RFID reader 1c in the check point 1, there occurs an electromotive force by an electromagnetic wave or electric wave acting from the RFID reader 1c, and the tag 1f sends a signal containing identification information to the reader 1c. Thus the RFID reader 1c detects the identification information of the goods 1e. Then the control equipment 3 receives the identification information from the controller 1a.

In addition, if the goods 1e enters in a view of the video camera 1b, the controller 1a detects the goods 1e from an image by a known image recognition technology, cuts out and outputs its image information. Then the control equipment 3 receives the image information from the controller 1a.

Here, in the detection of the image information of the goods 1e input from the video camera 1b and that of the identification information of the RFID tag 1f in the RFID reader 1c, a detection order thereof is not always same according to an installation position of the camera 1b and the reader 1c, and an affixation position and individual difference of the tag 1f. Therefore, if the control equipment 3 receives either the identification information or the image information from the controller 1a (step S100), it determines whether or not to have received not acquired image information or identification information not received from the controller 1a (step S101).

Here, if the control equipment 3 has not received the not acquired identification information or image information (No in the step S101), it waits for a predetermined time till receiving the not acquired identification information or image information according to a condition loop indicated in step S102; furthermore, if the control equipment 3 has not received only one of the not acquired identification information and image information (Yes in the step S102), it executes a predetermined timeout processing (step S103) as having failed the detection of the goods 1e in the check point 1, and ends all processings.

Here, because the case of the timeout has a higher possibility of the RFID tag 1f being defective such as a read defect, no affixation, and double affixation thereof, it can be thought of as the predetermined timeout processing to send the controller 1a information of displaying “making a person in charge investigate the RFID tag 1f” in the display 1d and the like.

In addition, if the control equipment 3 has received both of the identification information and the image information till the predetermined time (Yes in the step S101), it searches, by the threshold information search mechanism 303, the type number of the goods 1e from the individual goods attribute DB 308, using the received identification information; and further searches, by the mechanism 303, the threshold information of the feature quantity of the goods 1e stored in the prescription goods feature quantity DB 309 (step S104), using the check point ID for identifying the controller 1a that sent the information of the searched type number and identification information.

Next, by the feature quantity extraction mechanism 301, the control equipment 3 extracts the image feature information from the image information of the goods 1e according to a known image processing technology (step S105). Here, as the image feature information of the goods 1e is thought of information relating to items, for example, such as the shape, size, and color like RGB (Red, Green, Blue) data. What physical quantities the control equipment 3 extracts as items of the image feature information in the step S105 is decided in advance, and the equipment 3 can extract not only an independent item but also a plurality of items in combination. In addition, it can also be thought of to take an image of an infrared ray radiated from the goods 1e by the video camera 1b and to detect a temperature of the goods 1e, and the like.

Meanwhile, in the step S104, as the threshold information of the feature quantity of the goods 1e searched from the prescription goods feature quantity DB 309 is searched the threshold information corresponding to the items of the image feature information extracted by the feature quantity extraction mechanism 301 in the step S105.

Next, by the comparison determination mechanism 304, the control equipment 3 compares the threshold information of the feature quantity of the goods 1e searched by the threshold information search mechanism 303 in the step S105 with the image feature information of the goods 1e extracted by the feature quantity extraction mechanism 301, determines whether or not the image feature information of the goods 1e has deviated from the threshold information, and outputs the determination result as determination information (step S106).

The determination information is output, for example, as binary information such as “O” or “x” as indicated in the item of “Determination Result” in Table 3 if the threshold information is a value having an upper limit value, a lower value, or a predetermined width. In addition, if the threshold information is divided into a plurality of areas, information for indicating which division the image feature information belongs to can be made the determination information.

If the control equipment 3 outputs the determination information, it produces the trace ID uniquely added to a record of the traceability DB 310 in order to specify information produced when the goods 1e passes through the check point 1. The registration mechanism 305 stores (step S107) the identification information of the received goods 1e, the check point 1, receiving time of the image information or the identification information, the determination information output by the comparison determination mechanism 304, and the like in the traceability DB 310 (see Table 3), with making them correspond to the trace ID.

Then the registration mechanism 305 makes the received image information, the image feature information extracted by the feature quantity extraction mechanism 301, and the like correspond to the trace ID, and stores them in the image feature quantity DB 311 (step S108).

Next, based on the determination information output in the step S106, the comparison determination mechanism 304 determines whether the determination information is normal or defective, that is, whether or not the image feature information extracted by the feature quantity extraction mechanism 301 has deviated from the threshold information (step S109). In the determination, if the image feature information has not deviated from the threshold information (No in the step S109), the control equipment 3 ends the processing relating to the goods 1e as it is. In addition, if the image feature information has deviated from the threshold information (Yes in the step S109), the control equipment 3 executes a predetermined error processing (step S110) and ends the processing relating to the goods 1e.

Here, as the predetermined error processing is thought of, for example, to output a screen display of indicating a rejection determination in the display 1d.

By executing such the processing shown in the flowchart of FIG. 4 every time when the goods 1e passes through the check point 1 installed in each distribution level, information relating the traceability of the goods 1e is accumulated in the traceability DB 310. In addition, because the image feature information and image information of when the goods 1e passes through the check point 1 stored in the image feature quantity DB 311 can be searched out of the information stored in the traceability DB 310 with making the trace ID as key information, it is enabled to investigate a cause of a defect, tracing a place where the check point 1 of each process and the like is installed when the defect occurs in the goods 1e.

Meanwhile, an example of performing a character recognition from the image information by the character recognition mechanism 302 in the goods trace information storing system of the embodiment will be described in an embodiment example described later.

### First Embodiment Example

Next will be described a first embodiment example where the goods trace information storing system described above is applied to goods of an agricultural product such as fruit and vegetables.

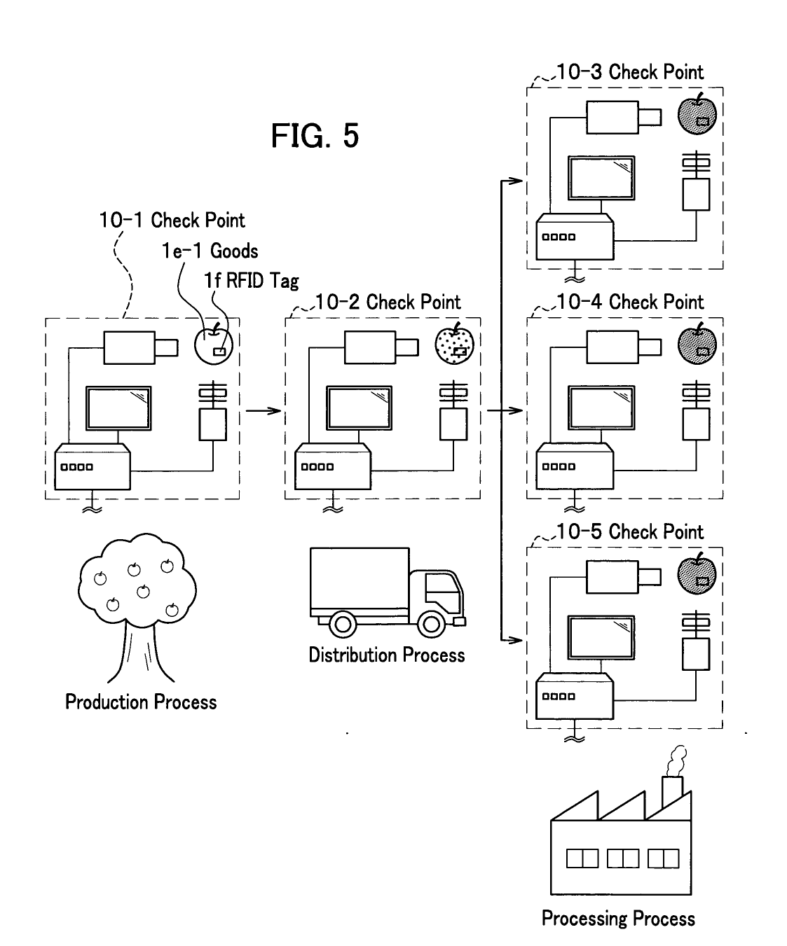

Here, FIG. 5 is a drawing illustrating the first embodiment example where the goods trace information storing system is applied to a distribution process of a goods 1e-1 of an agricultural product such as fruit and vegetables. In the distribution process shown in FIG. 5 the goods 1e-1 of the agricultural product is produced by a producer and the RFID tag 1f is affixed before shipping in a production process. In addition, in a delivery process the goods 1e-1 shipped by the producer is delivered to a processing plant and the like for processing the goods 1e-1 by a delivery company and the like. Then in a processing process the goods 1e-1 delivered to the processing plant by the delivery company is processed and delivered as a processed product.

In such the distribution process, because the goods 1e-1 is an agricultural product, it results in being degraded in freshness with time. Therefore, in order to deliver the goods 1e-1 having prescribed freshness from a producer to a processing plant, it is necessary to ship the goods 1e-1 to a processing plant at a proper address, considering a delivery time in a delivery process. The goods trace information storing system of the embodiment example is preferably applicable to such the freshness control. Here will be described each process of the embodiment example in detail (see FIGS. 1 to 4 as needed).

Meanwhile, in the goods trace information storing system shown in FIG. 5 is omitted such an illustration of the network 2 and the control equipment 3 shown in FIG. 1, and check points 10-1, . . . , 10-5 are connected to the control equipment 3 via the network 2 not shown.

In addition, an example of applying the goods trace information storing system within a plant in such a processing process will be described in detail in a second embodiment example described later.

[Production Process]

Referring to FIG. 5, to the goods 1e-1 is affixed the RFID tag 1f in advance before shipping, and the individual goods attribute DB 308 and the prescription goods feature quantity DB 309 as shown in Table 1 are input.

Then the goods 1e-1 where the RFID tag 1f is affixed is placed on such a belt conveyor when shipped and passes through the check point 10-1, and information such as identification information, image information, and determination information is stored in predetermined data bases of the control equipment 3.

In order to measure freshness of the goods 1e-1, the feature quantity extraction mechanism 301 of the control equipment 3 extracts color information as image feature information from the image information. As the color information can be used the RGB data digitalized.

Furthermore, in the prescription goods feature quantity DB 309 is stored threshold information, for example, divided into three areas as shown in Table 5, and thus as determination information is output information relating the freshness such as “Freshness A,” “Freshness B,” and “Freshness C.” In addition, the goods 1e-1 having the image feature information deviated from the threshold information is determined as a “freshness defect” and the determination information is displayed in the display 1d installed at the check point 10-1.

TABLE 5
Example of Information Stored in Prescription
Goods Feature Quantity DB

| Check Point ID | Freshness A | Freshness B | Freshness C | . . . |
|---|---|---|---|---|
| 10-1 | R(255-240) | R(240-230) | R(230-220) | . . . |
| | G(0-50) | G(0-60) | G(0-70) | |
| | B(0-35) | B(0-35) | B(0-40) | |
| 10-2 | R(255-230) | R(230-220) | R(220-210) | . . . |
| | G(0-55) | G(0-65) | G(0-75) | |
| | B(0-40) | B(0-45) | B(0-50) | |
| . | . | . | . | . |
| . | . | . | . | . |
| . | . | . | . | . |

In the production process the goods 1e-1 determined as the “freshness defect” is sorted and discarded by the producer, and the goods 1e-1 other than this is shipped to the delivery process.

Meanwhile, in the embodiment example, because the goods 1e-1 is known to be a specific agricultural product, information relating to a type number (product kind) is not included in the prescription goods feature quantity DB 309 shown in FIG. 5. In addition, by storing the threshold information relating to the size of the goods 1e-1 as the threshold information stored in the prescription goods feature quantity DB 309 and extracting the size information of the goods 1e-1 as the image feature information, it is also enabled to sort the goods 1e-1 according to the size.

[Delivery Process and Processing Process]

Next, the goods 1e-1 shipped to the delivery process again receives a freshness determination by the check point 10-2 provided at a package receiving place of the delivery process. Determination information output at this time is displayed in the display 1d of the check point 10-2.

Here, in the delivery process, although the goods 1e-1 is delivered to a subsequent processing process, a delivery time differs depending on a distance and a transportation means (track, railway, ship, and the like), for example, in a case that the goods 1e-1 is processed in a plurality of remote processing plants, the freshness of the goods 1e-1 results in being degraded according to the delivery time. Accordingly, it is necessary to deliver the goods 1e-1 of higher freshness by priority to a processing plant that takes a longer delivery time. By determining the freshness of the goods 1e-1 received at the check point 10-2, the delivery company can sort a delivery destination according to the freshness.

The goods 1e-1 of which a processing plant of the delivery destination is decided by the check point 10-2 is delivered to a processing process, and when the goods 1e-1 is received in the processing plant where the processing process is performed, a final freshness determination of the goods 1e-1 is performed in the check points 10-3, 10-4, and 10-5 installed in respective processing plants, and a processing thereof is performed.

Meanwhile, in the embodiment example, although the check point 10-2 is provided at one place in the delivery process for the description, it is enabled to provide a plurality of the check points 10-2 in a case that the delivery process is divided into a plurality, and that a delivery time is longer. In addition, also in the processing process it is enabled to determine the goods 1e according to the image feature information other than the freshness by appropriately changing a combination of the threshold information and the image feature information extracted, same as in the production process and the delivery process.

In accordance with the embodiment example thus described, it is enabled to accumulate the information relating to the traceability by using the goods trace information storing system while controlling the freshness. In addition, in a case that there exists the goods 1e-1 of a freshness defect, it is enabled to speedily investigate a place, where the freshness of the goods 1e-1 is degraded, and a cause thereof.

### Second Embodiment Example

Next will be described a second embodiment example where the goods trace information storing system of the embodiment is applied to an inspection process of goods in a processing process.

In the second embodiment example, assuming a processing product such as a bottled product consisting of a plurality of kinds as the goods 1e, will be described an inspection process that inputs information stored in the individual goods attribute DB 308 shown in FIG. 3, inspects such a breakage of the goods 1e, and performs sorting for shipping by using the goods trace information storing system of the embodiment (see FIGS. 1 to 3 as needed).

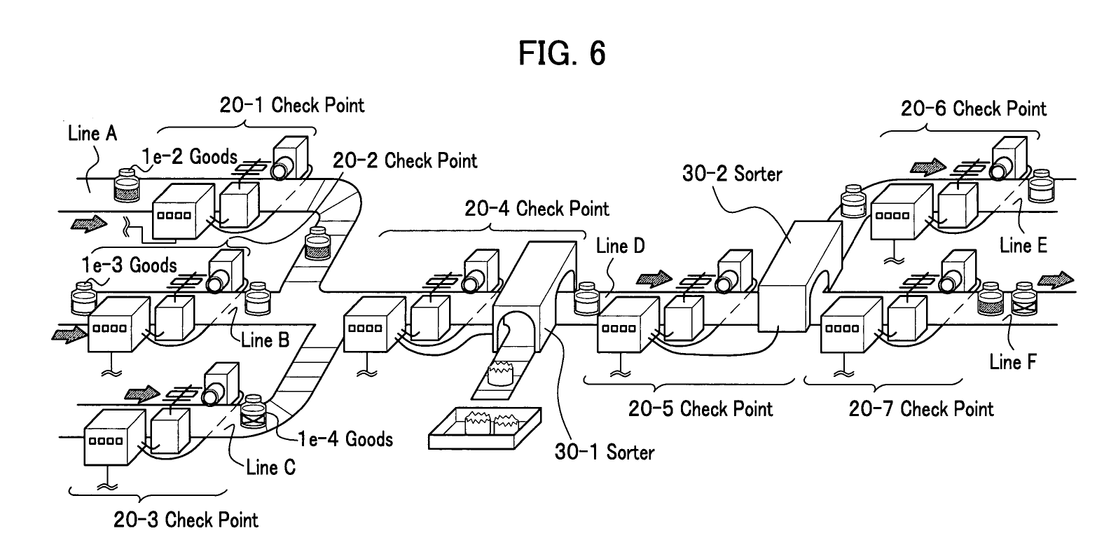

Here, FIG. 6 is a drawing illustrating the embodiment example where the goods trace information storing system is applied to an inspection process of goods 1e-2, 1e-3, and 1e-4 of processing products.

In the processing process shown in FIG. 6, firstly, the goods 1e-2, 1e-3, and 1e-4 of respective different processing products flow therein from lines A, B, and C of belt conveyor lines and pass through check points 20-1, 20-2, and 20-3 provided at respective lines. To the goods 1e-2, 1e-3, and 1e-4 are affixed respective commercial product labels where information such as a product type number and a manufacturing number is printed together with the RFID tag 1f; and at the check points 20-1, 20-2, and 20-3 the control equipment 3 recognizes these pieces of the information as a character and acquires them as information stored in the individual goods attribute DB 308 (see Table 1). Here will be in detail described a procedure of acquiring the information of the manufacturing number printed on the commercial product label and storing the acquired manufacturing number in the individual goods attribute DB 308.

Meanwhile, Here is assumed that the product type numbers of the goods 1e-2, 1e-3, and 1e-4 flowing in from each line are decided in advance according to the line. In addition, although in the embodiment example the check points 20-1 to 20-7 are assumed to be a configuration of each display 1d being omitted, of course it is also enabled to comprise the display 1d and display such a determination result performed in the check points 20-1 to 20-7.

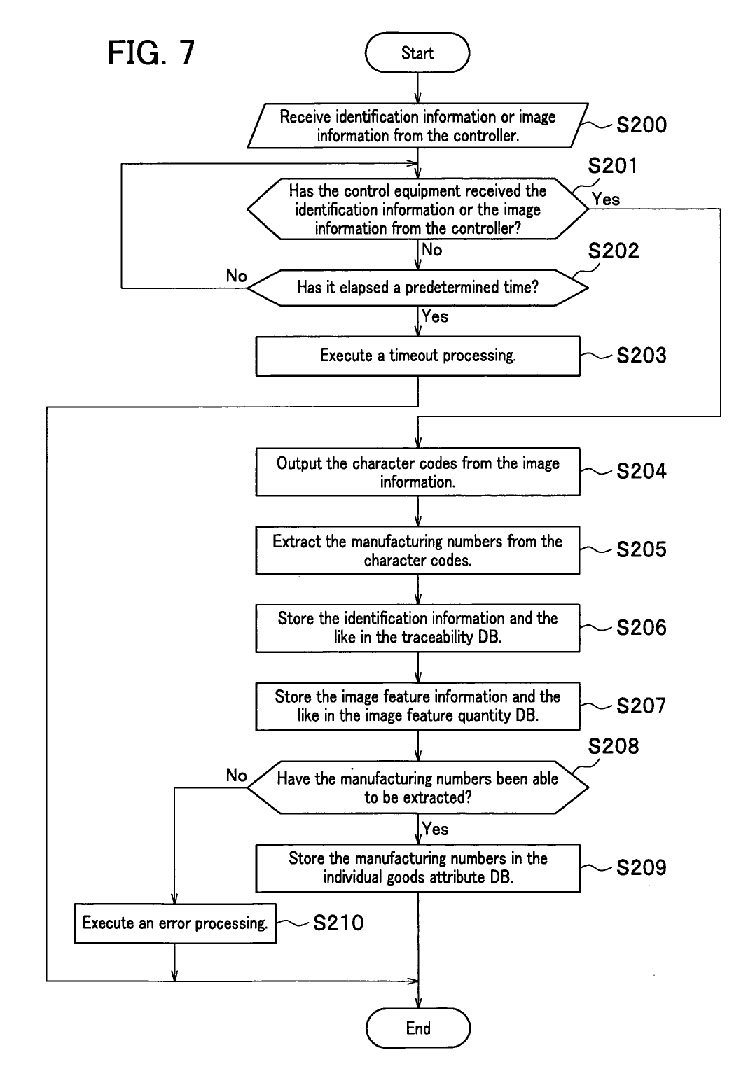

Here, FIG. 7 is a flowchart illustrating a procedure of the control equipment 3 storing acquired information in each data base when the goods 1e-2, 1e-3, and 1e-4 pass through the check points 20-1, 20-2, and 20-3, respectively. In the flowchart shown in FIG. 7, because a procedure relating to steps S200 to S203 is same as thoes describing the operation of the check point 1 shown in FIG. 4, a description thereof will be omitted.

In the step S201, if the control equipment 3 receives identification information and image information from the controller 1a (Yes in the step S201), it executes a character recognition of characters printed on commercial product labels affixed to the goods 1e-2, 1e-3, and 1e-4 from received image information and outputs character codes by the character recognition mechanism 302 (step S204). Furthermore, the character recognition mechanism 302 extracts manufacturing numbers of the goods 1e-2, 1e-3, and 1e-4 from the output character codes (step S205). At this time, if positions of the manufacturing numbers printed on the commercial product labels are known in advance, the characters printed on the positions are recognized as the manufacturing numbers. In addition, if the positions of the manufacturing numbers printed on the commercial product labels are not specified, it is enabled to prepare pattern data of the manufacturing numbers in advance and to extract character sequences matching patterns of those of the manufacturing numbers as the manufacturing numbers.

Next, the registration mechanism 305 of the control equipment 3 stores the received identification information of the goods 1e-2, 1e-3, and 1e-4, check point IDs, receiving time of the image information or the identification information in the traceability DB 310 (see Table 3) with making them correspond to the trace IDs generated in order to specify information produced when the goods 1e-2, 1e-3, and 1e-4 pass through the check points 20-1, 20-2, and 20-3 (step S206). Then the registration mechanism 305 makes the received image information correspond to the traceability IDs and stores it in the image feature quantity DB 311 (see Table 4) (step S207).

Next, the control equipment 3 determines whether or not the feature quantity extraction mechanism 301 can have extracted the manufacturing numbers from the image information (step S208). Here, If the control equipment 3 determines that the manufacturing numbers cannot be extracted (No in the step S208), it executes a predetermined error processing (step S210), and ends all processings.

Meanwhile, as the predetermined error processing it can be thought of to acquire such the manufacturing numbers of the goods 1e-2, 1e-3, and 1e-4 manually input by a person in charge of the inspection process.

In addition, if the control equipment 3 determines that the manufacturing numbers can have been extracted (Yes in the step S208), the registration mechanism 305 makes the information of the extracted manufacturing numbers correspond to identification numbers acquired from the RFID tags 1f and stores it in the individual goods attribute DB 308 (see Table 1) (step S209). Via the procedure thus described, at the check points 20-1, 20-2, and 20-3 is stored predetermined information in the traceability DB 310 and the image feature quantity mechanism 311; and the identification information and manufacturing numbers of the RFID tags 1f affixed to the goods 1e-2, 1e-3, and 1e-4 are made to correspond to each other, and are stored in the individual goods attribute DB 308.

Again returning to FIG. 6, the goods 1e-2, 1e-3, and 1e-4 of which the manufacturing numbers are read at the check points 20-1, 20-2, and 20-3 are collected to a line D from the lines A, B, and C, and receive an inspection of a breakage at the check point 20-4. To the check point 20-4 is connected a sorter 30-1, and the goods 1e-2, 1e-3, and 1e-4 determined to be broken are sorted to a discard tray 40 and discharged from the line D. At the check point 20-4 is determined the breakage of the goods 1e-2, 1e-3, and 1e-4 by extracting shapes thereof as the image feature information from the image information.

Next, the goods 1e-2, 1e-3, and 1e-4 having passed through the check point 20-4 are sent to the check point 20-5. To the check point 20-5 is connected a sorter 30-2, and the goods 1e-2, 1e-3, and 1e-4 are sorted to a line E or F according to content amounts thereof. At the check point 20-5 is executed sorting determinations of the goods 1e-2, 1e-3, and 1e-4 by extracting liquid level heights thereof as the image feature information from the image information, and by determining the content amounts.

Then at the check point 20-6 provided in the line E and the check point 20-7 provided in the line F, for example, as a final quality inspection before shipping are inspected colors of contents of the goods 1e-2, 1e-3, and 1e-4, being extracted as the image feature information, and the information is inspected whether or not to have deviated from predetermined threshold information.

Via the process thus described, the goods 1e-2, 1e-3, and 1e-4 flow in from the lines A, B, and C, respectively; receive various inspections; flow out from the lines E and F; and are transferred to a subsequent process.

In accordance with the embodiment example thus described it is enabled to accumulate the information relating to the traceability by using the goods trace information storing system while performing quality control. In addition, it is enabled not only to speedily investigate the cause of a quality defect but also to make the identification information stored in the RFID tags if and the manufacturing numbers of the goods 1e-2, 1e-3, and 1e-4.

Thus although the two embodiment examples are described, the goods trace information storing system of the embodiment is variously applicable other than these if it takes a mode of the goods 1e distributing.

For example, in a case that the goods trace information storing system of the embodiment is applied to a delivery service such as a door-to-door delivery service, it is also enabled to operate the goods trace information storing system in conjunction with a system for sorting the goods 1e by taking an image of an invoice affixed to the goods 1e with the video camera 1b, and by recognizing it as a character at the check point 1 provided at an upper stream. At this time it is enabled to determine an address not existing in information of an address file as a “defect” by storing the information of the address file as “reference information” in the prescription goods feature quantity DB 309.

Furthermore, it may also be designed to remove the goods 1e determined as the “defect” from a delivery line, or to deliver it to a delivery base confirmed to be a correct address, and for a worker to correct the address at the delivery base. In a case of correcting the address at the delivery base confirmed to be the correct address, a configuration is preferable that the registration mechanism 305 of the control equipment 3 automatically transfers character information or image information used in a determination to a predetermined check point 1 of a delivery base, where a correction is performed, from another check point 1 where the character information or the image information is determined as a “defect” at the time of the goods 1e being determined as the “defect,” and displays the character information or the image information in the display 1d; and thus at the delivery base where the correction is performed, the worker can see the address and the like in advance and prepare the correction.

The goods trace information storing system of the embodiment is various changeable and performable by changing an extracted feature quantity and being combined with such a known production control system and the traceability system disclosed in Japanese Patent Laid-Open Publication No. 2004-78743 described before.

Accordingly, the present invention is not limited to the embodiment but defined by the technical ideas described in the claims.

What is claimed is:

1. A goods trace information storing method for storing information relating to a distribution history of goods, where a tag for storing at least identification information is attached, in a plurality of distribution levels, the method comprising the steps of:
acquiring said identification information from said tag in each distribution level by an identification information read mechanism, and acquiring physical property information of said goods, where said tag is attached, by a physical quantity measurement mechanism; and
a registration mechanism's comprising information for identifying a distribution level where said identification information and said physical property information are acquired, making said identification information and said physical property information correspond to information for identifying the information group, and storing said identification information and said physical property information in a memory mechanism.

2. The goods trace information storing method according to claim 1, wherein a storing step in said memory mechanism further comprises information of time when said identification information and said physical property information are acquired, makes said identification information and said physical property information correspond to information for identifying said information group, and stores said identification information and said physical property information in said memory mechanism.

3. The goods trace information storing method according to claim 1, wherein said physical quantity measurement mechanism comprises an image input mechanism and a feature quantity extraction mechanism for extracting a feature quantity of said goods as said physical property information from an image of the goods taken by said image input mechanism.

4. The goods trace information storing method according to claim 2, wherein said physical quantity measurement mechanism comprises an image input mechanism and a feature quantity extraction mechanism for extracting a feature quantity of said goods as said physical property information from an image of said goods taken by said image input mechanism.

5. The goods trace information storing method according to claim 1,
wherein a comparison determination mechanism further comprises the steps of comparing said physical property information with predetermined threshold information and outputting determination information that comprises information for indicating whether or not said physical property information is out of a range of said threshold information after acquiring said identification information and said physical property information, and
wherein in the step of storing said identification information in said memory mechanism said registration mechanism further comprises and stores said determination information in said memory mechanism.

6. The goods trace information storing method according to claim 2,
wherein a comparison determination mechanism further comprises the steps of comparing said physical property information with predetermined threshold information and outputting determination information that comprises information for indicating whether or not said physical property information is out of a range of said threshold information after acquiring said identification information and said physical property information, and
wherein in the step of storing said identification information in said memory mechanism said registration mechanism further comprises and stores said determination information in said memory mechanism.

7. The goods trace information storing method according to claim 3,
wherein a comparison determination mechanism further comprises the steps of comparing said physical property information with predetermined threshold information and outputting determination information that comprises information for indicating whether or not said physical property information is out of a range of said threshold information after acquiring said identification information and said physical property information, and
wherein in the step of storing said identification information in said memory mechanism said registration mechanism further comprises and stores said determination information in said memory mechanism.

8. The goods trace information storing method according to claim 4,
wherein a comparison determination mechanism further comprises the steps of comparing said physical property information with predetermined threshold information and outputting determination information that comprises information for indicating whether or not said physical property information is out of a range of said threshold information after acquiring said identification information and said physical property information, and
wherein in the step of storing said identification information in said memory mechanism said registration mechanism further comprises and stores said determination information in said memory mechanism.

9. The goods trace information storing method according to claim 3 further comprising the steps of:
converting a character included in an image of said goods taken by said image input mechanism to a character code and extracting a predetermined character sequence as character information from the character code by a character recognition mechanism, after acquiring said identification information and said physical property information,
wherein in the step of storing said information group in said memory mechanism said registration mechanism further comprises and stores said character information in said memory mechanism.

10. The goods trace information storing method according to claim 9, wherein a predetermined character sequence extracted by said character recognition mechanism is a character sequence uniquely added to said goods.

11. The goods trace information storing method according to claim 9, wherein when a comparison determination mechanism compares said character information with predetermined reference information and there exists no matching information, the comparison determination mechanism comprises the step of sending and displaying at least said character information to and in a display mechanism provided at a predetermined distribution level in a subsequent stage after extracting said character information.

12. The goods trace information storing method according to claim 1, wherein said tag is an RFID (Radio Frequency Identifier) tag and said identification information read mechanism is an RFID reader.

13. A goods trace information storing system for accumulating information relating to a distribution history of goods, where a tag for storing at least identification information is attached, in a plurality of distribution levels, the system comprising:
an identification information read mechanism for acquiring said identification information stored in said tag in each distribution level;
a physical quantity measurement mechanism for acquiring physical property information of said goods;
a memory mechanism for storing said identification information and said physical property information; and
a registration mechanism comprising information for identifying a distribution level where said identification information and said physical property information are acquired, making said identification information and said physical property information correspond to information for identifying the information group, and storing said identification information and said physical property information in said memory mechanism.

14. The goods trace information storing system according to claim 13, wherein said registration mechanism further comprises information of time when said identification information and said physical property information are acquired, makes said identification information and said physical property information correspond to information for identifying said information group, and stores said identification information and said physical property information in said memory mechanism.

15. The goods trace information storing system according to claim 13, wherein said physical quantity measurement mechanism comprises an image input mechanism and a feature quantity extraction mechanism for extracting a feature quantity of said goods as said physical property information from an image of said goods taken by the image input mechanism.

16. The goods trace information storing system according to claim 13 further comprising:
a comparison determination mechanism for comparing said physical property information with predetermined threshold information and outputting determination information that comprises information for indicating whether or not said physical property information is out of a range of said threshold information,
wherein said registration mechanism further comprises and stores said determination information in said memory mechanism.

17. The goods trace information storing system according to claim 15 further comprising:
a character recognition mechanism for converting a character included in an image of said goods taken by said image input mechanism to a character code and extracting a predetermined character sequence as character information from the character code,
wherein said registration mechanism further comprises and stores said character information in said memory mechanism.

18. The goods trace information storing system according to claim 17, wherein a predetermined character sequence extracted by said character recognition mechanism is a character sequence uniquely added to said goods.

19. The goods trace information storing system according to claim 17 further comprising:
a comparison determination mechanism for comparing said character information with predetermined reference information, and sending and displaying at least said character information to and in a display mechanism provided at a predetermined distribution level in a subsequent stage, when there exists no matching information.

20. The goods trace information storing system according to claim 13, wherein said tag is an RFID tag and said identification information read mechanism is an RFID reader.
